(19) United States
(12) Patent Application Publication
(10) Pub. No.: US 2003/0188610 A1
(43) Pub. Date: Oct. 9, 2003

(54) Hexagonal head wrench assembly

(76) Inventor: Chiang Her Lin, Taichung (TW)

Correspondence Address: CHARLES E. BAXLEY, ESQUIRE, Hart, Baxley, Daniels & Holton, 59 John St, 5 Fl., New York, NY, 10038, US

(21) Appl. No.: 10/114,737

(22) Filed: Apr. 4, 2002

(51) Int. Cl. B25B 23/00

(52) U.S. Cl. 81/440

(57) ABSTRACT

The present invention relates to a hexagonal head wrench assembly that includes a tubular body with a plurality of passages defined longitudinally therethrough for receiving the hexagonal head wrenches. A wedge-shaped recess is defined in an outer periphery of the body and a magnet is engaged in the recess so that a short end of the hexagonal head wrench is secured engaged in the recess.

### FIELD OF THE INVENTION

The present invention relates to a hexagonal head wrench assembly that includes a tubular body in which hexagonal head wrenches are received. A short end of the hexagonal head wrench is secured engaged in a wedge-shaped recess defined in wedge-shaped recess.

### BACKGROUND OF THE INVENTION

A conventional hexagonal wrench assembly is shown in FIG. 1 and includes a box 20 in which a plurality of hexagonal head wrenches 22 are received. Each of the hexagonal head wrenches 22 has a T-shaped handle so that the users hold the T-shaped handle to rotate the hexagonal head wrenches 22. An inherent problem of the conventional hexagonal head wrench assembly is that the T-shaped handles 21 occupy too much room in the box 20 so that the users need to have a large box 20 to receive these hexagonal head wrenches 22.

### SUMMARY OF THE INVENTION

In accordance with one aspect of the present invention, there is provided a hexagonal head wrench assembly which comprises a body having a plurality of passages for hexagonal head wrenches received therein. A wedge-shaped recess is defined in an outer periphery of the body so that a short end of one of the hexagonal head wrenches is secured in the recess.

The primary object of the present invention is to provide a tubular body which can be used as a T-shaped handle and a means for receiving the wrenches.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a conventional hexagonal head wrench assembly;

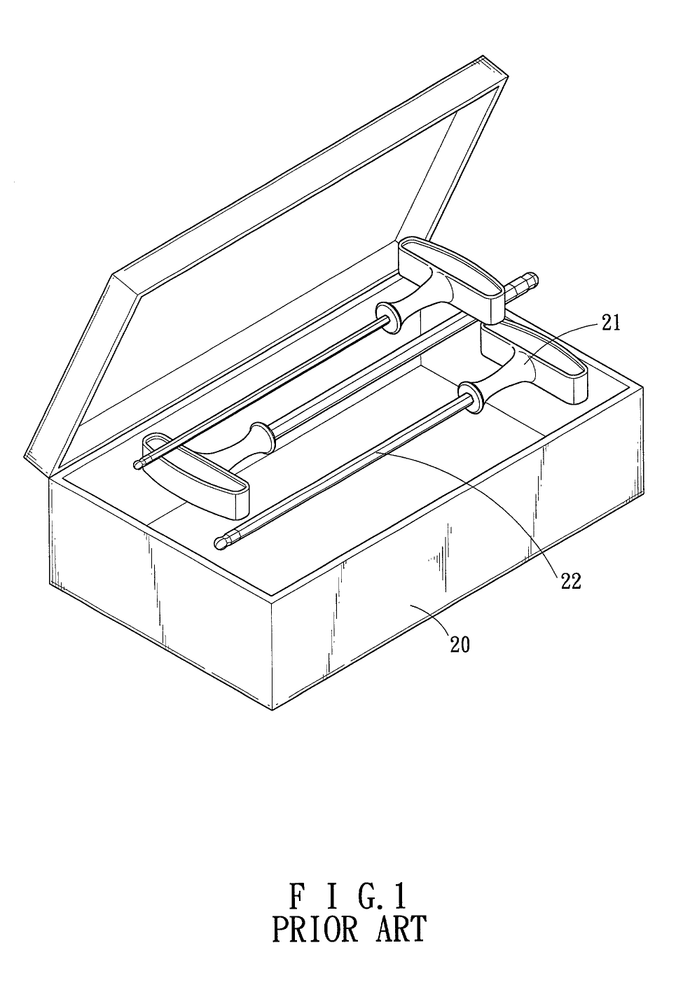

FIG. 2 is an exploded view to show hexagonal head wrench assembly;

FIG. 3 is a perspective view to show the hexagonal head wrenches are received in the passages in the body;

FIG. 4 is an end view to show the hexagonal head wrench assembly of the present invention, and

FIG. 5 is a cross sectional view to show a short end of the hexagonal head wrench is engaged with the recess in the body.

### DETAILED DESCRIPTION OF THE PREFERRED EMBODIMENT

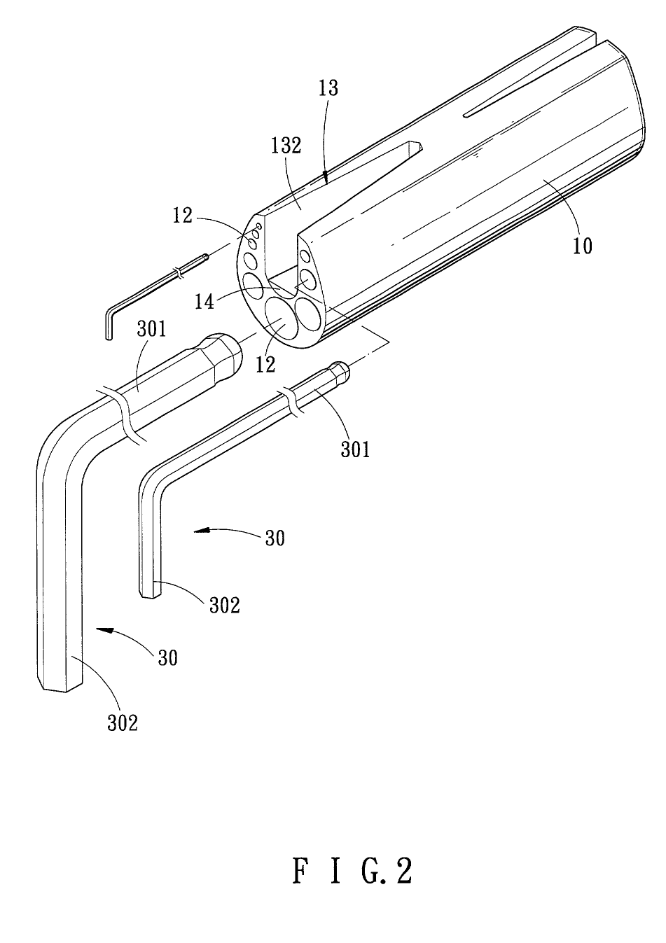

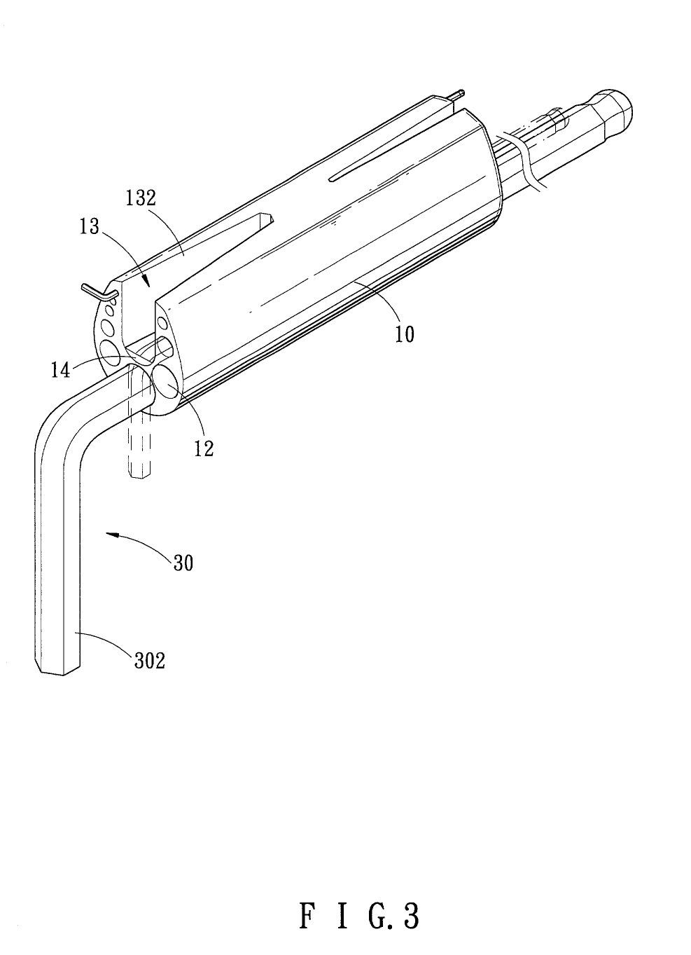

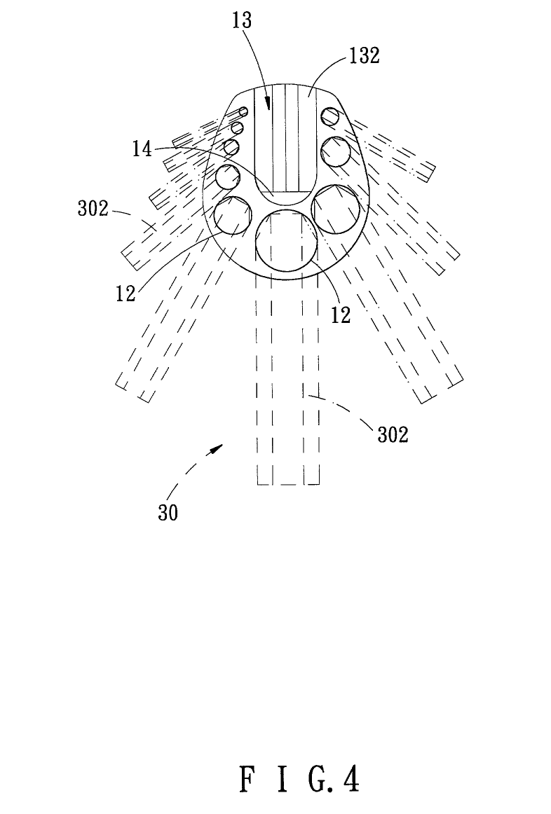

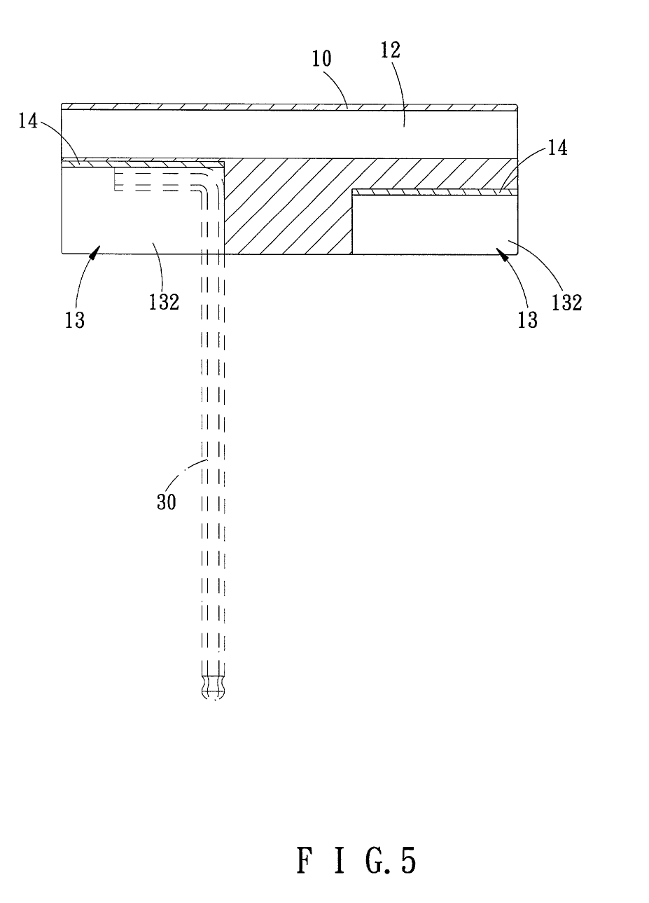

Referring to FIGS. 2 to 5, the hexagonal head wrench assembly of the present invention comprises a tubular body 10 having a plurality of passages 12 defined longitudinally therethrough so that the respective long ends 301 of the hexagonal head wrenches 30 are received in the passages 12, and the respective short ends 302 extending from an end of the body 10 as shown in FIG. 4.

A wedge-shaped recess 13 is defined in an outer periphery of each of the two ends of the body 10. Each recess 13 comprises two tapered insides 132 and opens to an end of the body 10.

A magnet 14 is engaged in each of the recesses 13 so that a short end 302 of one of the hexagonal head wrenches 30 is secured in the recess 13 by the two tapered insides 132. The short end 302 is also positioned by the magnet 14 so that the body 10 can be used as a T-shaped handle to rotate the hexagonal head wrenches 30 and the rest of the hexagonal head wrenches 30 can be still received in the passages 12 of the body 10.

The size of the two recesses 13 are different so as to position the short ends 302 of the hexagonal head wrenches 30 that have small sizes.

While we have shown and described the embodiment in accordance with the present invention, it should be clear to those skilled in the art that further embodiments may be made without departing from the scope of the present invention.

What is claimed is:

1. A hexagonal head wrench assembly comprising:
a body having a plurality of passages defined longitudinally therethrough and a wedge-shaped recess defined in an outer periphery of the body, the recess comprising two tapered insides and opening to an end of the body.

2. The assembly as claimed in claim 1 further comprising a magnet engaged in the recess.
